(19) United States
(12) Patent Application Publication
(10) Pub. No.: US 2025/0153464 A1
(43) Pub. Date: May 15, 2025

(54) ILLUMINABLE ENAMELLED SUBSTRATE AND ITS MANUFACTURE

(71) Applicant: SAINT-GOBAIN GLASS FRANCE, COURBEVOIE (FR)

(72) Inventor: Florian FLAMARY MESPOULIE, COURBEVOIE (FR)

(21) Appl. No.: 18/836,083

(22) PCT Filed: Feb. 7, 2023
(86) PCT No.: PCT/FR2023/050162

§ 371 Date: Aug. 6, 2024

(30) Foreign Application Priority Data
Feb. 8, 2022 (FR) FR2201107

(51) Int. Cl. B32B 17/10; B32B 1/00; B32B 37/24; B32B 38/00; F21V 8/00

(52) U.S. Cl. CPC B32B 17/10045; B32B 1/00; B32B 17/10495; B32B 17/10541; B32B 17/10651; B32B 17/10788; B32B 37/24; B32B 38/0012; B32B 38/0036; B32B 38/145; G02B 6/0043; G02B 6/0065; G02B 6/0073; B32B 2037/243; B32B 2255/20; B32B 2305/345; B32B 2307/4026; B32B 2307/412; B32B 2307/422; B32B 2329/04; B32B 2329/06; B32B 2419/00; B32B 2605/00

(57) ABSTRACT

An enameled substrate includes a first glass sheet including, on a first main face, a scattering layer made of scattering enamel, including a glassy matrix, the layer including at least a first scattering pattern of at least 0.1 mm and a of given surface area S0, wherein the glassy matrix is glass-crystalline, thus including microcrystals in a vitreous binder, the microcrystals being scattering and wherein the first scattering pattern is discontinuous, the scattering layer includes a content by weight of coloring additives of at most 10% of the total weight of the enamel.

The invention relates to the field of enameled substrates used to form luminous glazed devices illuminated by means of a light source.

Inorganic light-emitting diodes are used to produce luminous glazed units in particular of a vehicle. The light emitted by the diodes is introduced via the edge face into the glazed unit forming a guide, the light being extracted from the glazed unit by a scattering layer on the glazed unit, defining the light surface. The scattering layer conventionally is a scattering enamel obtained by screen printing containing dielectric scattering particles such as alumina particles dispersed in the glassy matrix. This is for example a flat enamel or even a set of screen-printed enamel spots 300 μm wide, at least given the resolution of the screen printing dictated by the size of the openings of the screen-printing screens. This luminous glazed unit has a very blurred appearance in the zone of the scattering layer. The light transmission of the enamel is less than 40%, the haze is 90 to 100%.

The present invention therefore seeks to develop an alternating scattering layer further increasing the transparency in the “off” state while remaining capable of extracting light.

For this purpose, the first object of the invention is an enameled substrate in particular for a luminous glazed device (in particular a land, marine, rail, or aerial vehicle or else a building or street furniture), including a first glass sheet (preferably clear or extra-clear, in particular colorless, and preferably soda-lime-silica glass, in particular with a refractive index n0 at 550 nm of 1.4 to 1.6, in particular of a thickness of at most 10 mm and even of at most 5 or 3 mm and preferably of at least 0.1 mm, 0.3 mm or 0.7 mm.

The scattering layer includes at least one first scattering pattern preferably with a width of at least 0.1 mm and even of at least 0.5 mm or even 1 mm, in particular with a length of at least 0.6 or 1 mm and even 1 cm, and of surface area S0 in particular of at least 100 μm by 600 μm.

The first glass sheet includes, on (directly or on a sub-layer) one (only one) first main face (tin face or opposite face if float glass), a scattering layer made of scattering enamel including a glassy matrix including a vitreous binder (preferably glass-crystalline in a vitreous binder with (micro)crystals generated—in situ—during firing with or without growth seeds).

The glassy matrix is glass-crystalline, thus including microcrystals in a vitreous binder, the microcrystals being scattering and the first scattering pattern is discontinuous.

The scattering layer preferably includes a content by weight of color additives of at most 10% of the total weight of the enamel

The first scattering pattern may comprise either a set of separate micropads of said scattering enamel or a continuous enamel zone with through holes.

The scattering layer is discontinuous:
preferably in a configuration it forms a set of separate micropads (and without a continuous zone of enamel layer).
or in an alternative configuration it includes a continuous zone with holes of submillimetric width, of at least 10 μm (and optionally includes micropads of enamel in the holes) with a higher haze and a lower transparency than in the other configuration.

In one configuration, the first scattering pattern (and even one or more scattering patterns of the scattering layer) includes a set of separate micropads of said scattering enamel, or even consists of said set of separate micropads. Between the micropads (defining an intercontact zone), the first sheet is preferably transparent (devoid of layer enamel, for example extending over at least 100 μm), the first main face preferably being bare or with the sublayer.

The micropads (all or some) may be of varied shapes, having a base with an irregular outline (in particular with a degree of circularity detailed later), and/or distributed in irregular or even random manner.

By defining within the first scattering pattern an analysis surface area S1 of less than S0, and S1 being at least 50 μm by 50 μm and at most 100 μm by 600 μm—for example 500 μm*340 μm—and a surface area S2 which is the sum of the surface areas of the micropads in this surface area S1:
the first scattering pattern is defined by an equivalent mean diameter Am (with micropads having a base reduced to a circle) of said micropads of less than 10 μm or less than or equal to 5 μm and of at least 1 μm
the first scattering pattern is defined by an average distance Bm between neighboring micropads and Bm/Am ranging from 0.3 to 2 or even to 1.5
preferably the first scattering pattern includes a degree of coverage Tm of said micropads that is the surface area S2 divided by the surface area S1, Tm is less than 50%, and even 45%, 40%, 35% or 30% and preferably at least 5%, 8%, 10%, 11%, 15%, 20%.

Preferably, the arrangement of micropads can be defined further by at least one of the following features:
the average distance Bm is less than 5 μm, 4 μm, or to 3 μm and better still is at least 1 μm,
in said analysis surface, the first scattering pattern is defined by an average perimeter Pm (preferably taken at the base) of at least 3 μm or 4 μm and preferably of less than 10 μm
in said analysis surface, the first scattering pattern is defined by a mean circularity Cm (preferably taken at the base) of at least 0.7 or 0.75, 0.8, or 0.85 and less than 1 or 0.95 and
at least for the first scattering pattern and preferably for the scattering layer in its entirety (first scattering pattern and one or other scattering patterns), the micropads (all or some) have a thickness of at most 4.5 μm, 4 μm or 3.5 μm or 3 μm and at least 0.5 μm or 1 μm.
at least in said analysis surface and preferably for the scattering layer in its entirety (first scattering pattern and one or other scattering patterns), the micropads of width (taken at the base) greater than 1 μm have a thickness of at least 0.5 μm or 1 μm.
at least in said analysis surface and preferably for the scattering layer in its entirety (first scattering pattern and one or other scattering patterns), the first scattering pattern includes, among the micropads, pads (called primary) with a diameter of 1 μm to 20 μm or 10 μm and pads (called secondary, more numerous than the primary pads) with a diameter of less than 1 μm and of at least 0.1 μm, in particular at least 70%, 80% or 90% of the micropads (in number) have a diameter of at most 20 μm or 15 μm or 10 μm or 5 μm,
at least in said analysis surface and preferably for the scattering layer in its entirety (first scattering pattern and one or other scattering patterns), the micropads have a curved surface in particular with an average contact angle of less than 160° or at 120° and even greater than 60°.

With such a pad arrangement, a substrate provided with one or more transparent patterns is obtained that does not significantly degrade the light transmission and with a decrease in haze, relative to a solid, continuous scattering layer. The use as automotive glazed unit, side window, rear window, glass roof, etc. is perfectly feasible.

The first scattering pattern alone or with one or more scattering patterns formed for the scattering layer are able to extract the light from the first glass sheet forming a light guide coupled to a light source.

In the case of a plurality of scattering patterns, by using enamels of various natures and/or thicknesses, therefore with different levels of transmission (semi-transparent, translucent) and/or arrangements of various spots (by adjusting the process parameters and/or the enamel paste), and the invention makes it possible to obtain a glazed unit capable of illuminating either simultaneously or sequentially in particular with more or less transparency.

With light sources (visible and even ultraviolet UV) of various natures, or even luminescent particles of various natures, the invention makes it possible to obtain a glazed unit capable of illuminating differently or even in several colors, simultaneously, or sequentially.

In a most conventional configuration, the enameled substrate is monolithic or is part of a laminate and/or a double glazed unit so as to preserve the transparency (an object can be seen behind the scattering layer or even to see the exterior, the sky for a vehicle roof). However, it is possible to want the enameled substrate with the scattering layer to be as invisible as possible in the off state and assembled with an additional opaque sheet or with an opaque layer behind that scattering layer.

The scattering layer may include the first scattering pattern alone or with one or other scattering patterns each with an arrangement of micropads identical to that described or similar while keeping the parameters Am, Bm, Bm/Am, Cm and their numbers. Another scattering layer may coexist in the form of a flat enamel, preferably occupying less than 10% of the transparent area of the first sheet.

The scattering layer of enamel is for example in contact with the first main face. It is possible to provide between the scattering layer and the first face a transparent underlayer (mono- or multilayer), preferably mineral, at least resistant to enamel firing, and even with a thickness of at most 1 μm or 0.2 μm as long as this thickness does not disturb the guidance and/or the extraction of light.

The glassy matrix is glass-crystalline, the micropads thus include microcrystals (generated during firing and not by adding particles in the liquid composition) in particular scattering in a vitreous binder (with frit of molten glass).

The microcrystals include all or some of elements of the vitreous binder, elements in the oxidized state. The microcrystals are defined compounds. The microcrystals are in the vitreous binder or on the surface, in particular present in so-called primary pads of at least 1 μm—in dendritic form, of needles. The microcrystals have a variety of non-calibrated, nonspherical, rather elongated shapes.

These microcrystals confer the advantage of diffusing light and can replace all or some of said additional scattering elements added into the binder, such as metal oxide pigments (white, colored, distinct from black, etc.).

The vitreous binder may preferably be dense or slightly porous, including gas or vacuum porosities which may form part of diffusing elements with microcrystals and/or scattering particles added (white or colored pigments).

The glass-crystalline matrix may be a (transparent) matrix, preferably colorless, in particular the volume fraction of vitreous binder being at least 80, 85 or 90% of the volume of the enamel and the remainder for the microcrystals and/or other scattering particles.

Preferably, for the vitreous binder, it is preferable to avoid the oxides of lead, cadmium, and mercury. It is preferable to avoid (or by weight content of less than 1% of the total weight of the enamel) the transition metal oxides from column 5 to 11 and even 12—except for zinc—of the periodic table of elements. The total content of alkaline oxides other than Na₂O (as Li₂O, K₂O) for the vitreous binder is preferably at most 3% by weight of the vitreous binder (and even of the enamel), in particular 2% and even 1% or 0.5%. In one case, the only present alkaline oxide is advantageously Na₂O. It is possible to limit to 5%, 2%, 1% or 0.5% by weight of the vitreous binder (and even of the enamel), the weight content of cumulative oxides of alkaline-earth metals Mg, Ca, or even Mg, Ca and Ba.

Furthermore, in a first embodiment, cumulatively:
for the vitreous binder, the weight content of silica SiO₂ is the highest,
the weight content of lead oxide PbO is at most 0.5%, the total weight of the vitreous binder (respectively the enamel) and better is zero, and also the weight content of cadmium, mercury or chromium oxide is zero.

The vitreous binder and/or microcrystals of the glass-crystalline matrix may contain oxides of at least the following elements: Si, Bi, Na, Zn, Ti, Al, B. The vitreous binder and/or the microcrystals of the glass-crystalline matrix may be based on bismuth and/or zinc silicate or bismuth and/or zinc borosilicate silicate.

Preferentially, concerning the composition of the scattering layer, one or more following alternative or cumulative characteristics are provided:
the weight content of the vitreous binder is at least 80% or at least 90%, of the total weight of the enamel
the enamel includes a content by weight of impurities of at most 0.5% of the total weight of the enamel
the total weight content of coloring elements (Fe₂O₃, CuO, CoO, Cr₂O₃, MnO₂, Se, Ag, Cu, Au, Nd₂O₃, Er₂O₃) is at most 0.5% and even 0.1% of the total weight of the vitreous binder and even of the glassy matrix and preferably zero (except inevitable impurities) in order for the enamel to be colorless or as little-colored as possible
the content by weight of coloring additives, such as pigments (metal oxide)—black or white or even colored—is preferably at most 5% or 1% of the total weight of the enamel, in particular 0.5% and even 0.1%, or even zero.

The enamel is preferably translucent, colorless or colored, whitish or with another color (without being completely opaque).

It is preferable to greatly limit, and better yet avoid, coloring additives such as a metal oxide pigment (mixed).

It is possible to greatly limit and even avoid:
one or more fillers such as silica and quartz alumina, refractory oxide fillers such as boro-alumina silicates, alumina silicates, calcium silicates, soda-calcium-alumina silicates, wollastonite, feldspar,
and/or other conventional additives, such as iron, silicon, zinc and the like, titanates.

Conventionally, the main faces of a laminated glazed unit (automobile or building) are numbered from 1 to 4:
Face F1 is the external (exterior) face of the exterior glass that is preferably tinted in a motor vehicle and
Face F2 is the internal face (lamination interlayer side) of the exterior glass
the lamination interlayer is preferably PVB or EVA
Face F3 is the internal face (lamination interlayer side) of the preferably colorless interior glass, often of a thickness less than or equal to that of the exterior glass
Face F4 is the internal face (passenger compartment side) of the interior glass

The enamel can be semi-transparent (in particular whitish with no or very little pigments).

The enamel can be less transparent or even opaque when the first face is opposite the observation face of the scattering light pattern, in particular:
the first face is Face F1 and the observation face is Face F2 (or the inverse if a visible pattern is desired on the exterior side)
or the observation face is Face F4 if the first sheet is the internal glass of a laminated glazed unit or within the laminated glazed unit (internal guide).

The enamel is translucent (the first face is opposite the observation face of the light pattern, in particular F2 or F4 if laminated).

The microcrystals can occupy a volume fraction of the micropads that may vary in size, for example at most 60% within the micropad, in particular the so-called primary micropads with a diameter equivalent to at least 1 μm. The size of the microcrystals (equivalent diameter) is less than the size (thickness and/or equivalent diameter) of the micropads. There may be disjoint microcrystals within the micropads (for example at least 5) in particular the so-called primary micropads with an equivalent diameter of at least 1 μm. They can emerge or remain within the micropads.

The microcrystals are preferably of a diameter, for example equivalent, (D50 or D90 in particular) to at least 0.1 μm, for example less than 2 μm and even to 1 μm.

The microcrystals and/or other scattering particles can occupy a volume fraction of the micropads that may vary in size, for example at most 60% within the micropad, in particular the so-called primary micropads with a diameter equivalent to at least 1 μm.

The scattering layer may optionally include (inorganic, refractory, in particular oxide) particles, in particular scattering particles optionally crystallized, which are additional (as added in the liquid composition), dispersed in the glassy matrix. These particles are detectable by X-ray diffraction known as “XRD”.

These scattering particles (distinct from possible growth seeds) are not necessary or in a reduced amount so as to reinforce the scattering.

The scattering particles are preferably with a diameter (D50 or D90 in particular) of at least 0.1 μm, for example less than 2 μm and even to 1 μm.

The scattering particles are for example solid and even optionally hollow particles, for example hollow silica. The scattering (non-luminescent) particles are chosen, for example, from particles of alumina, zircon, silica, titanium dioxide, calcium carbonate, barium sulfate, and in particular they are (white) pigments.

The scattering layer may optionally also include scattering particles alone or in combination with the added scattering particles.

The scattering layer (may include a volume fraction of scattering porosities of at most 10% or 5% or 1% of the volume of the enamel (in the first scattering pattern).

The scattering layer may include a content by weight of scattering particles (additional particles, optionally added apart from crystallization seeds in the glass-crystalline matrix) of at most 10% or 5% or 1% of the total weight of the enamel and even as low as 0%.

The size of the scattering particles (equivalent diameter), other than the microcrystals, is less than the size (thickness and/or equivalent diameter) of the micropads. There may be scattering particles within the micropads (for example at least 5) in particular the so-called primary micropads with an equivalent diameter of at least 1 μm. They can emerge or remain within the micropads.

In one embodiment, the scattering layer includes at most 5% by weight of luminescent (inorganic) particles. The luminescent particles are dispersed in the vitreous binder of the glass-crystalline matrix.

When the scattering layer comprises luminescent particles, preferably a light source is added, such as a light-emitting diode (LED), emitting light of a wavelength at which the luminescent particles are excited and re-emit light in the visible region. This or these LEDs may be positioned like LEDs emitting in the visible. This excitation wavelength is for example in the UV in particular UVA, and potentially 365 at 400 or 390 nm. It is possible to consider LEDs emitting both at this excitation wavelength and in the visible.

By using scattering particles of various kinds, and/or light sources of various kinds, or even luminescent particles of various kinds, the invention makes it possible to obtain a glazed unit capable of illuminating in several colors, simultaneously or sequentially.

The scattering patterns may have varied, symmetrical or asymmetrical shapes. The distribution of the scattering patterns on the substrate may be periodic or aperiodic. A periodic distribution means that the scattering patterns are placed on the first glass sheet in an ordered manner while an aperiodic distribution means that the scattering patterns are placed on the first glass sheet randomly. The scattering patterns may have any shape and be more or less large. It may however be desired that the scattering layer extend over a region of the first main face, for example, extend over at most 50%, 40% or 30% or 20%, 10%, 1%, 0.1% of the first face.

The scattering layer can be distributed over the entire transparent area even until it is adjacent to an opaque zone (edge) such as the masking frame.

For example, the scattering layer is local, at the periphery of the first face.

The scattering layer may cover less than 50% of the surface area of the first glass sheet when it is necessary to preserve a clear window area that is as transparent as possible in the off state.

A peripheral luminous strip can be formed along a lateral or longitudinal, lower or upper edge of the first glass sheet.

The luminance is preferably at least 1 Cd/m².

The scattering layer may be spaced apart by at least 10 mm or even 40 mm from the light injection zone (wall of a hole in the first sheet, edge face, edge of the light-redirecting element). It is therefore possible to have a transparent zone with a width of at most 40 mm between the injection zone and the edge of the closest scattering layer.

The first glass sheet (made of extra-clear glass preferably) with the scattering layer preferably has:
a light transmission factor of at least 70%, 75%, 80%, 85% and even at least 90% preferably in the sense of the EN 410:1998 standard,
a (transmission) haze of at most 80% and even of at most 20% or 15% or 5%
and preferably a clarity of at least 80%, 90%, 95%.

In particular, the first glass sheet (made of extra-clear glass preferably) with the scattering layer preferably has:
a light transmission factor of at least 70% or 75%, and a haze (in transmission) of at most 80% or 70%
a light transmission factor of at least 80%, and a haze (in transmission) of at most 55%
a light transmission factor of at least 85%, and a haze (in transmission) of at most 30%
a light transmission factor of at least 90%, and a haze (in transmission) of at most 6%.

Advantageously, the haze is at most 30%, the clarity is at least 90% or 95%, the light transmission factor is at least 88%.

In one embodiment, during the haze measurement, the light spot is centimetric at the surface of the scattering layer, in particular of at most 5 cm, in particular of about 2.6 cm, and in the zone illuminated by the spot the scattering layer (with the first scattering pattern) preferably occupies at least 30%, 50%, 60% of the spot.

The light transmission factor TL can be calculated using the illuminant D65, the measurement being carried out for example using a spectrophotometer equipped with an integrating sphere, the measurement at a given thickness then being converted, where appropriate, to the reference thickness of 4 mm according to the standard EN 410:1998.

Haze and even clarity are preferably measured by a Hazemeter (such as the BYK-Gardner Haze-Gard Plus), preferably according to standard ASTDM D1003 (without compensation).

The measurements are preferred before possible lamination. For example, the illuminant is placed opposite the first carrier face of the scattering layer.

Furthermore, the scattering layer may comprise a gloss in terms of gloss unit (ub) of at least 60 or 80 and better still at least 100, indicating a smooth surface.

The scattering layer is preferably a monolayer (obtained by depositing a single layer based on glass frit).

Furthermore, the glass with the scattering layer (the first pattern) may include a lightness L* of at most 60 and even of at most 40 or 30.

Furthermore, the glass with the scattering layer (the first pattern) may include an optical density of at most 0.4 and even of at most 0.2.

The thickness (or maximum height) of the micropads can be determined by observation in a sectional view of the scattering layer using a scanning electron microscope at a magnification of 250× (for example with a voltage of 20 KV).

The parameters Am, Bm, Tm, Cm, Pm can be determined from the processing and analysis of a black-and-white SEM image of the surface with a scanning electron microscope at a magnification of 250×.

For the SEM image, the CBS (Concentric Backscattered) mode is chosen. CBS is a backscattered electron detector that gives images in chemical contrast

For example, for the processing and analysis of SEM Images, the software called Image J is used.

For each SEM image, SEM image thresholding is carried out from 90 to 255; thus a threshold of 90 is fixed from which any pixel having an intensity greater than or equal to the threshold 90 is assigned the value 255 and the rest of the pixels will be 0.

The surface area S1 is chosen for example to be 500 μm over 340 μm within the first scattering pattern.

All particle sizes are taken into account by default as well as all circularities.

The number of isolated pads is counted and the parameters Am, Bm, Tm, Cm, Pm are measured.

The evaluation can be repeated in several regions of the first scattering pattern or even of the scattering patterns for a more representative calculation of the parameters.

Preferably, the arrangement of micropads can be defined further by at least one of the following features:
the average distance Bm is less than 5 μm, 4 μm, or to 3 μm and better still is at least 1 μm,
in said analysis surface, the first scattering pattern is defined by an average perimeter Pm (preferably taken at the base) of at least 3 μm or 4 μm and preferably of less than 10 μm
in said analysis surface, the first scattering pattern is defined by a mean circularity Cm (preferably taken at the base) of at least 0.7 or 0.75, 0.8, or 0.85 and less than 1 or 0.95.

Alternatively or cumulatively (with two scattering units), the discontinuous enamel layer (at least the first scattering pattern) can comprise a continuous enamel zone having separate (micrometric) openings (through-holes). The openings are of irregular shape and size and are distributed irregularly.

By defining within the first scattering pattern said continuous enamel zone with openings, an analysis surface area S′1 less than S0, and S′1 being at least 50 μm by 50 μm and at most 100 μm by 600 μm—for example 500 μm*340 μm—and a surface area S′2 which is the sum of the surface areas of the micropads in this surface area S′1
the first scattering pattern is defined by an equivalent mean diameter A′m (with openings having a base reduced to a circle) of said openings of less than 20 μm or 10 μm and even at least 1 μm
the first scattering pattern is defined by an average distance Bm between said neighboring openings to 20 μm or 10 μm of at least 1 μm
preferably the first scattering pattern includes a degree of coverage T′m of said openings, which is the surface area S′2 divided by the surface area S′1, T′m is less than 50%, and even 45%, 40%, 35% or 30% and preferably at least 5%, 8%, 10%, 15%.

The parameters A′m, B′m, T′m, and blank of the surface with a scanning electron microscope at a magnification of 250 times.

The CBS (Concentric Backscattered) mode is chosen for the SEM image. CBS is a backscattered electron detector that gives images in chemical contrast

Software called J Image is used, for example, for processing and analyzing SEM images. For each SEM image, SEM image thresholding is carried out from 90 to 255; thus, a threshold de 90 is fixed from which any pixel having an intensity greater than or equal to the threshold 90 is assigned the value 255 and the rest of the pixels will be 0. The surface area S′1 is chosen for example to be 500 μm over 340 μm within the first scattering pattern. All particle sizes are taken into account by default as well as all circularities. The number of openings is counted and the parameters A′m, B′m, T′m are measured.

The first glass sheet may be with main faces that are rectangular, square or even any other shape (round, oval, polygonal). The glass sheet may have a size of greater than 1.5 m².

The glass of the first glass sheet (and even of the other optional glass sheet(s)) is preferably of the float glass type. In this case, the scattering layer may equally well be deposited on the “tin” side as on the “atmosphere” side of the substrate.

Other features may be provided for the first glass sheet:
the first glass sheet is curved or even tempered.
the first glass sheet is tempered in particular by thermal tempering (after firing in a rapid cooling tempering furnace, typically by nozzles), the firing in the tempering furnace being able to be used to form the enamel layer from a liquid composition (paste)—optionally with drying beforehand—based on glass frit

For a roof (often tinted), non-zero light transmission TL is preferred, and even of at least 0.5% or of at least 2% and of at most 40% and even of at most 8%.

It may be desirable for the scattering layer to form a light marker, one or more light signs. In the present application, the term “sign” should be understood to mean an iconic and/or linguistic signifier, that is to say using symbols (numbers, pictograms, logos, symbolic colors, etc.) and/or letters or words.

In one embodiment, the surface of the scattering layer may be a free surface (no other element(s) above).

This may be Face F4 of a laminated glazed unit or Face F1 or F2 of a monolithic glazed unit alone or else the external or internal face of a double glazed unit

In one embodiment, the first glass sheet is monolithic, which optionally forms part of a double glazed unit, the scattering layer has a surface which is free or covered by a functional element.

The functional element is optionally transparent, preferably with a thickness of at most 1.5 mm or submillimetric thickness, in particular:
a polymeric film in adhesive contact with the scattering layer
and/or a functional overlayer (monolayer or multilayer).

It may be a film bonded with an optical adhesive on the first main face, and in particular the enameled substrate is a monolithic glazed unit (not part of a laminate or a multiple glazed unit).

The polymeric film may be tinted and/or may bear a functional layer (electrically conductive, low-E, heating, etc.). Alternatively, the tinted polymeric film bearing a functional layer is bonded to the second main face.

The polymeric film may have a thickness of between 5 μm and 1 mm, preferably of at least 50 μm and of at most 200 μm. The polymeric film may be chosen from a polyester, in particular a polyethylene terephthalate (PET), a polyethylene naphthalate (PEN), a polycarbonate (PC), a polyolefin such as a polyethylene (PE), a polypropylene (PP), a polyurethane, a polyamide, a polyimide.

PET is preferred due to its transparency, its surface quality, its mechanical strength and its availability, at all sizes. The absorption of this transparent film, in particular of PET, is preferably of less than 0.5% or even of at most 0.2% and with a haze of less than 1.5% and even of at most 1%. The optically clear adhesive is in particular (a resin) based on polyester, acrylic or silicone. It can be a pressure-sensitive adhesive (PSA).

In one embodiment, the first glass sheet forms part of a laminated glazed unit (optionally curved) including:
said first sheet, in particular colorless, made of clear or extra-clear glass
a lamination interlayer, in particular colorless or even tinted
and a second transparent or tinted transparent sheet, preferably of clear or extra-clear glass or even tinted glass or a plastic such as a poly(methyl methacrylate PMMA or polycarbonate PC).

Preferably, the first main face is lamination interlayer side, the scattering layer being in adhesive contact with the lamination interlayer or covered (on) by a functional element optionally in adhesive contact with the lamination interlayer.

Preferably, the laminated glazed unit comprises a light source, such as light-emitting diode LED. The LED(s) may be in or near a (through)hole in the interior glass sheet for optical coupling through the wall delimiting the hole, or it/they may face the edge of the interior glass sheet.

The enameled substrate can therefore further comprise a light source, in particular a plurality of inorganic light-emitting diodes, which is optically coupled to the first glass sheet forming a light guide, in particular the injection of light from the light source by an edge face of the first glass sheet or a wall of a hole in the first glass sheet or by the first main face or a second main face opposite to the first main face, in particular direct optical coupling or by means of an optical system, in particular a light redirecting element on the first or second main face and offset from the scattering layer.

The first glass sheet may be monolithic, which optionally forms part of a double glazed unit, the scattering layer has a free surface or one covered by a functional element including a film and/or a coating (in particular a functional element in contact with the scattering layer and in particular in the interpad zone between the micropads in contact with the first bare face or with a sublayer as already described).

The first glass sheet may be part of a laminated glazed unit including:
said first sheet, preferably made of clear or extra-clear glass
a lamination interlayer preferably made of PVB, optionally tinted
and a second transparent glass or plastic sheet, preferably tinted,
   preferably, the first main face is the lamination interlayer side, the scattering layer being in adhesive contact with the lamination interlayer or covered by a functional element (in particular functional element in contact with the scattering layer and in particular in the interpad zone between the micropads in contact with the first bare face or with a sublayer as already described), preferably in adhesive contact with the lamination interlayer.

The first sheet is the internal glazing and preferably the first main face is the internal face called face F3 or the first sheet is between the second transparent sheet and a third glass sheet (forming an internal light guide, within the lamination interlayer).

The laminated glazed unit may include a functional element, in particular a transparent functional element, chosen from one or more of the following elements:
a silica layer, in particular a porous one, and for example sol-gel, forming an antireflective layer
a masking layer optionally adjacent to the scattering layer, in particular peripheral, in particular a enamel layer
an electrically conductive layer, in particular an electrode, a layer for electrical supply of (opto)electronic components or a heating layer, in particular a transparent conductive oxide layer, in particular within the laminated glazed unit
a solar control (and/)or low-emissivity layer, in particular a coating on the Face F4 including a functional layer of transparent conductive oxide or a metallic functional layer within the laminated glazed unit
within the laminated glazed unit (between the Faces F1 and F4), an electrically-controllable device, in particular a variable scattering and/or tint, in particular with liquid crystals or electrochromic tint, or an optical valve (SPD for suspended particle device) or a multi-pixel screen (liquid crystal, active matrix OLED, etc.) for example as described in patent application WO2017/115036 or an additional light element, electrically controllable device offset or facing the scattering layer,
a low index optical insulator element with a refractive index less than the refractive index of the first glass sheet, between the first face and the tinted second glass sheet, in particular between the first face and the tinted lamination interlayer, in particular a porous silica layer on the first face or a fluorinated film, in particular chosen from ethylene tetrafluoroethylene (ETFE), fluorinated ethylene-propylene copolymers (FEP).

A porous sol-gel silica layer with a refractive index of at most 1.3 or even at most 1.2 and better still of a thickness of at least 200 nm or even of at least 400 nm and preferably of at most 1 μm is described in application WO2008/059170 in particular in FIG. 11 or in application WO2015/101745.

In a light configuration for the exterior, the first glass sheet may be the external glazing and preferably the first main face is the internal face called Face F2.

In one configuration, the enameled substrate forms a glazed unit for a land, water or aerial vehicle, or as glazed panel for a building, in particular:
a curved laminated roof, the first glass sheet is the internal glazing or between a second glass sheet and a transparent glass or polymer sheet
a rear window, in particular the first glass sheet is the external glazing, the scattering layer is on the passenger compartment side
a side, laminated or monolithic (pane), the first glass sheet is the internal or external glazing
a curved laminated windshield, the first glass sheet is the internal or external glazing.

It is preferable for a lamination interlayer (clear or tinted) to be selected with as little haze as possible, that is to say of at most 1.5% and even of at most 1%.

These interlayer spacers may be based on polymers chosen from amongst polyvinylbutyrals (PVB), polyvinyl chlorides (PVC), polyurethanes (PU), polyethylene terephthalate or ethylene vinyl acetates (EVA). The interlayers preferably have a thickness in the range between 100 μm and 2.1 mm, preferably in the range between 0.3 and 1.1 mm. The lamination interlayer may be made of polyvinyl butyral (PVB), of polyurethane (PU), of ethylene/vinyl acetate copolymer (EVA), formed from one or more films, having for example a thickness between 0.2 mm and 1.1 mm. It is possible to choose a conventional PVB such as RC41 from Solutia or Eastman.

The lamination interlayer may optionally be composite in its thickness (PVB/plastic film such as polyester, PET, etc./PVB).

The surface of the lamination interlayer can be less than the surface of the laminated glazed unit, for example leaving a free groove (as a frame or as a headband), therefore not laminated.

For a laminated windshield, the lamination interlayer may have a wedge-shaped transverse cross section that decreases from the top of the laminated windshield to the bottom in particular to avoid double images in the case of an additional head-up display (HUD). The lamination interlayer may be acoustic.

The second sheet may have a larger size than the first, thus extending beyond the latter over at least a part of its perimeter, in particular when the first sheet is illuminated by its peripheral edge face, the light source like the LED modules can then rest on Face F2 of the second sheet, where the latter extends beyond the first sheet.

As an example of glazed units that are offset or not, with glazed units illuminated by the edge, mention may be made of patent applications WO2010/049638, WO2013079832, WO2013153303.

The first glass sheet may include a masking layer that is often peripheral on the first or second face, for example a black or dark opaque enamel layer forming a peripheral strip or even a peripheral frame.

The scattering layer may be more central, offset from the masking layer.

The first glass sheet may in particular comprise a masking layer, in particular made of enamel, adjacent to the scattering layer or on the second face, offset from the scattering layer, in particular peripheral masking layer along the optical coupling edge face with a light source.

Preferably at least in the guide zone, the width of this layer is eliminated or limited along the optical coupling edge face (between the edge face and the edge of the scattering layer) to less than 5 cm or even 3 cm.

More broadly,
the interior glazing(often the first glass sheet) may have a peripheral inner masking layer (may be a black or dark enamel layer, a paint layer or an opaque ink preferably on Face F2 or on the lamination interlayer, or even on an additional carrier film (PET, etc.).
and/or the exterior glazing (sometimes the first glass sheet) may have a peripheral outer masking layer (respectively outer masking layer) which is a black or dark enamel layer, a paint layer or an opaque ink preferably on Face F2 (respectively F3 or F4) or on the lamination interlayer, or even on an additional carrier film (PET, etc.).

Advantageously, the exterior and interior masking layers consist of the same material preferably of an enamel, in particular a black enamel and on F2 and F4 or on F2 and F3.

The scattering layer may be on Face F3:
in a resist of the inner masking layer on Face F3 or Face F4
facing the outer masking layer on Face F2.

In the alternative embodiment (colorless exterior glass, for example a rear window) the scattering layer may be on Face F2:
in a resist of the outer masking layer on Face F2
and even facing the inner masking layer on Face F3 or F4.

The first glass sheet may comprise, under the scattering layer and/or on a second main face opposite the first main face with the enamel scattering layer and/or on the first face under the scattering layer and/or adjacent to the scattering layer, a transparent functional layer, as long as this layer does not significantly impede the light guide function (by its absorption, etc.).

There are several types of functional layers (on the first glass sheet or in the laminated glazed unit) chosen from at least one of the following layers:
a masking layer adjacent to the scattering layer, in particular peripheral, in particular an enamel layer, preferably having a width of less than 5 cm or 3 cm between the optical coupling edge face and the closest edge of the scattering layer
an electrically-conducting layer, in particular an electrode (electrically conductive layer connected to a power supply), a layer (forming a circuit) for electrically powering (opto)electronic components (sensors, etc.)—the components, if possible, being as transparent and/or discrete as possible—in particular a transparent conductive oxide layer,
an electromagnetic shielding layer
a heating layer, that is to say an electrically-powered electrically-conductive layer (typically by two current supply bands),
a layer reflecting or absorbing solar radiation, referred to as solar control layer (and/)or low emissivity layer, in particular a coating including (at least) a functional layer of transparent conductive oxide (TCO) or (at least) a metallic functional layer, a solar control layer which can also serve as heating layer with a current supply at the periphery.

The electrically-conducting layer can comprise transparent conducting oxides (TCO), that is to say materials which are both good conductors and transparent in the visible, such as indium oxide doped with tin (ITO), tin oxide doped with antimony or with fluorine (SnO₂:F) or zinc oxide doped with aluminum (ZnO:Al).

The electrically conductive layer may also be a metal layer, preferably a thin layer or a stack of thin layers, called TCC (for “transparent conductive coating”), for example made of Ag, Al, Pd, Cu, Pt In, Mo, Au and typically of a thickness between 2 and 50 nm. A polymeric film coated with an electrically conductive layer can be used, for example, a clear PET Film called XIR from Eastman, a coextruded PET-PMMA Film, for example of the SRF type from 3M® (SRF for Solar Reflecting Film).

In a preferred embodiment in the case of laminated glazed unit (sunroof, etc.):
the first and/or second glazed unit is tinted and/or the lamination interlayer is tinted over an entire part of its thickness
Face F4 is coated with a transparent electrically conductive oxide layer (called TCO) in particular a stack of thin layers with a TCO layer
and/or preferably Face F2 or F3 is coated with a stack of thin layers with silver layer(s).

Mention may be made, as a TCO-based low-emissivity layer, of those described in patent US2015/0146286, on Face F4, in particular in examples 1 to 3.

The light source preferably comprises a plurality of inorganic light-emitting diodes even if it is possible to envisage other types such as, for example, a light strip (OLED, etc.).

Another object of the invention is the use of a laminated glazed unit obtained by a manufacturing method described above, as a glazed unit for land, water or air vehicles, or as a glazed panel for buildings, in particular as a motor vehicle glazed unit, especially a motor vehicle roof.

Thus, the invention also relates to the method for manufacturing the enameled substrate in particular as described above, which comprises, on a first main face of a first glass sheet, the formation of a scattering layer of scattering enamel including a glassy matrix, (the scattering layer including a first scattering pattern with a width of at least 0.1 mm) involving in this order:
depositing on the first glass sheet a film of a liquid vitrifiable composition called enamel paste, including a mixture of an organic medium and an inorganic solid including a glass frit with a given glass transition temperature Tg1,
preferably drying (in particular infrared or even ultraviolet) at a temperature of at most 200° C.
firing at a temperature Tc above the glass transition temperature Tg1 of the glass frit to form the glassy matrix.

The glass frit is crystallizable and the enamel paste preferably includes growth seeds, the firing generates the formation of a glass-crystalline matrix including scattering microcrystals and the scattering layer is discontinuous.

Advantageously, the deposition is by screen-printing.

The firing can generate a set of separate micropads of said scattering enamel, micropads containing the microcrystals, the enamel paste preferably includes a percentage of inorganic solid including the crystallizable glass frit which is at most 50% by weight of enamel paste, and even at most 30%, 20%, 15%, 10% or 5% and in particular at least 0.5%, 1% or 5%.

The term “crystallizable glass frit” preferably means that at least 30% by weight of the oxides contained in the glass frit reacts during firing to form crystals. Suitable oxide frits comprise borosilicate frits, for example bismuth borosilicate frits and zinc borosilicate frits. More details on glass frits are in U.S. Pat. Nos. 5,153,150 6,207,285 and EP1888333.

The enamel paste may optionally contain up to approximately 20% (for example 0.1 to 20% or 2 to 10%), growth seeds such as bismuth silicates, zinc silicates and bismuth titanates. The seeds may comprise, without limitation, one or more of Zn2SiO4, Bi2SiO20, Bi4(SiO4)3, Bi2SiO5, 2ZnO·3TiO2, Bi2O3·SiO2, Bi2O3·2TiO2, 2Bi2O3·3TiO2, Bi7Ti4NbO21, Bi4Ti3O12, Bi2Ti2O7, Bi12TiO20, Bi4Ti3O12 and Bi2Ti4O11. Examples are in U.S. Pat. Nos. 6,624,104 and 5,208,191 or EP1888333.

The organic medium comprise or even consist of one or more of the following organic compounds of alcohols, esters, glycols, in particular glycol esters, terpineol. Terpinineols, or terpineols, are unsaturated monocyclic monoterpene alcohols (monoterpenols) of empirical formula C₁₀H₁₈O;

The medium may comprise or even consist of one or more of the following organic compounds: ethyl ether and diethylene glycol, butyl ether and diethylene glycol ether, plant oils, mineral oils, low molecular weight petroleum fractions, tridecyl alcohol, synthetic or natural resins (for example cellulosic resins or acrylate resins), propylene glycol monomethyl ether (PM), dipropylene glycol monomethyl ether (DPM), tripropylene glycol monomethyl ether (TPM), propylene glycol monobutyl ether (PnB), dipropylene glycol monobutyl ether (DPnB), tripropylene glycol n-butyl ether (TPnB), propylene glycol n-propyl ether (PnP), dipropylene glycol n-propyl ether (DPnP), tripropylene glycol n-butyl ether (TPnB), propylene glycol monomethyl ether acetate (PMA), Dowanol DB (diethylene glycol monobutyl ether) sold by Dow Chemical Company, USA, or other ethylene glycol or propylene glycol ethers.

Drying makes it possible to eliminate the vast majority of the solvent (at least 80% for example) by limiting the risks of contamination of the surface by dust which would impact the transparency of the scattering layer

The method may comprise an operation of bending the first glass sheet, said firing occurring during bending and optionally followed by tempering.

In particular, the firing furnace may be in an industrial curving (tempering) line. The tempering does not modify the optical characteristics of the scattering layer.

Curving takes place by gravity sag, for example as described in patents WO2007138214, WO2006072721, or by suction, for example as described in patent WO02/064519.

The glass frit is preferably in the form of particles the D90 of which is at most 20 μm, in particular 5 μm, or even 4 μm. The distribution of particle diameters can be determined using a laser granulometer.

In the case of screen printing, use is preferably made of a screen made of textile or metal mesh, cross-lapping tools, and a squeegee, the thickness being controlled by the choice of the mesh of the screen and its tension, by the choice of the distance between the first glass sheet and the screen, by the movement pressures and speeds of the squeegee.

The screen-printing screen may be more or less fine, for example 90T, 120T, 150T and 180T where T corresponds to the number of wires per cm.

The parameter that can influence the size of the micropads and even on the formation “threshold” for a layer in separate micropads (for a paste of given composition) is the thickness of the liquid film.

The thickness E0 of the liquid film depends on method parameters such as speed deposited, pressure of the screen-printing squeegee . . . .

In particular, the amount of inorganic solid per unit of printed surface area will influence the result.

The glass-crystal scattering layer is anti-adhesive or “antistick”. The glass sheet with the fired enamel layer can therefore be curved. The glass sheet with the enamel paste layer can be fired during curving.

The present invention will be better understood and other details and advantageous features of the invention will become apparent upon reading the examples of the motor vehicle luminous glazed device according to the invention shown by the following figures:

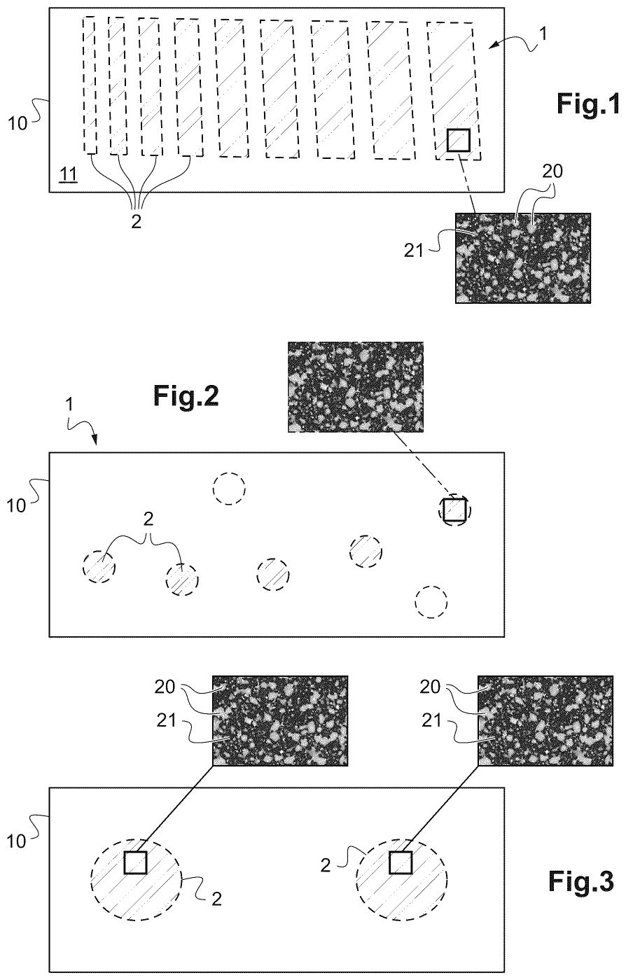

FIGS. 1 to 3 are schematic views of illuminable enameled glazed units 1 according to the invention.

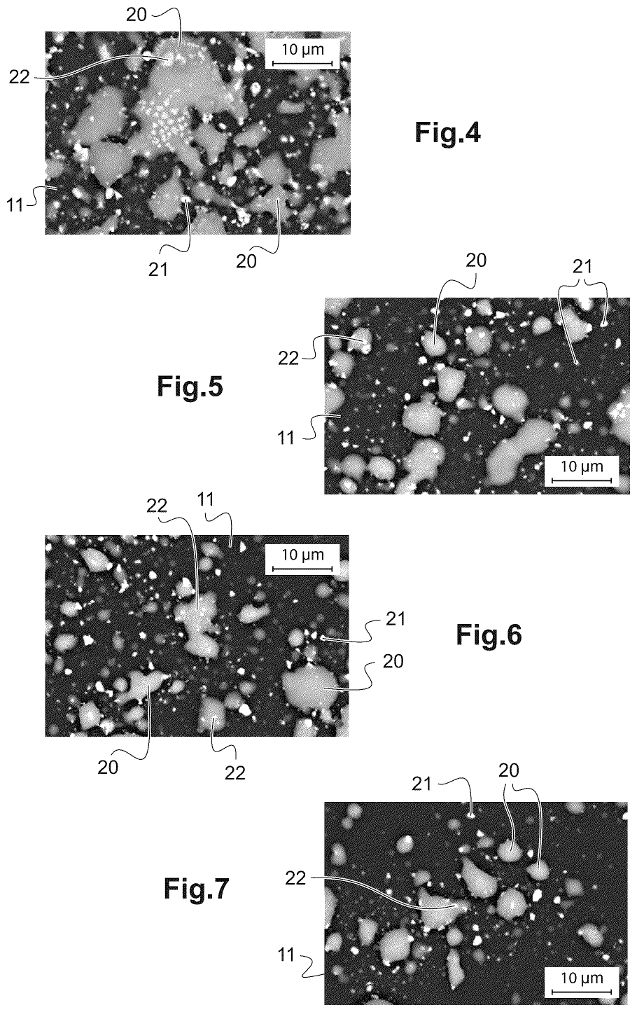

FIGS. 4 to 7 are SEM scanning electron microscopy photographs of the surfaces of the surfaces of the enameled glazed units according to the invention in examples No. 1 to 4.

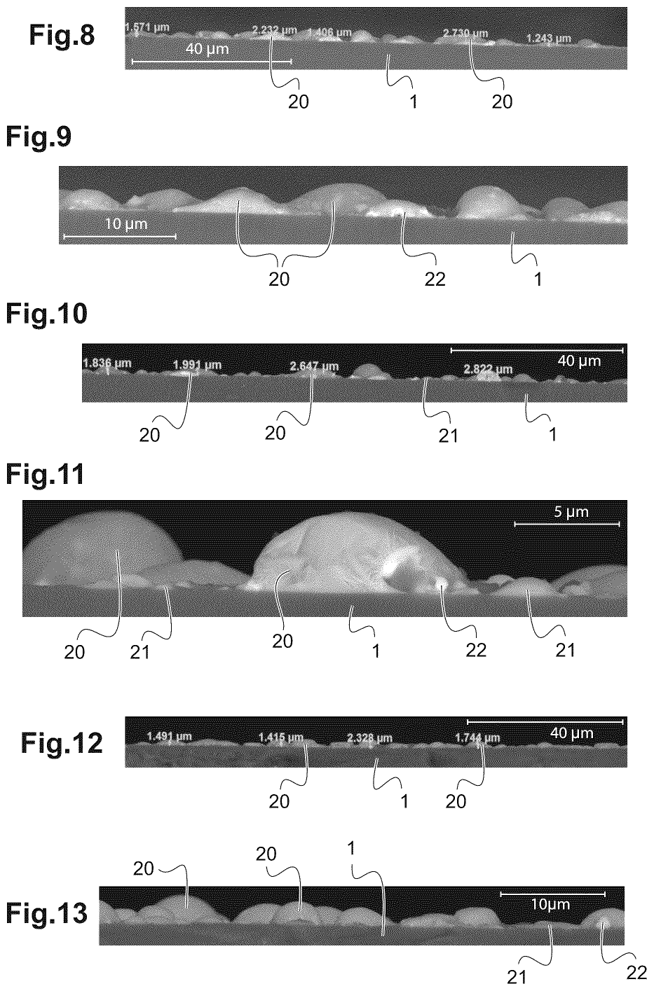

FIGS. 8 to 13 are photographs by SEM in cross-section of the enameled glazed units according to the invention in examples No. 1, 2 and 4.

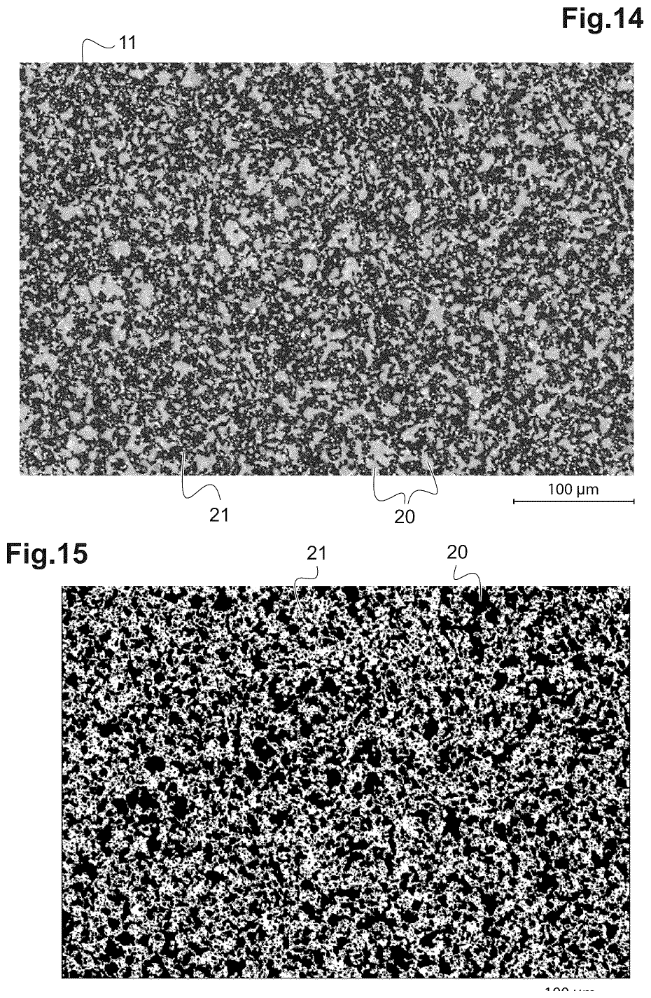

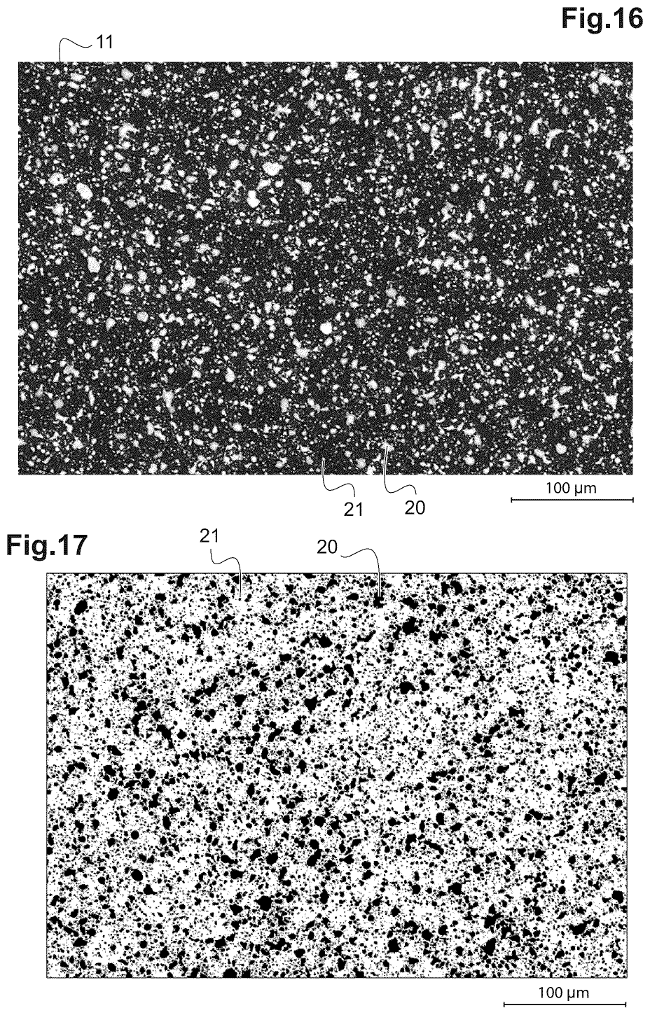

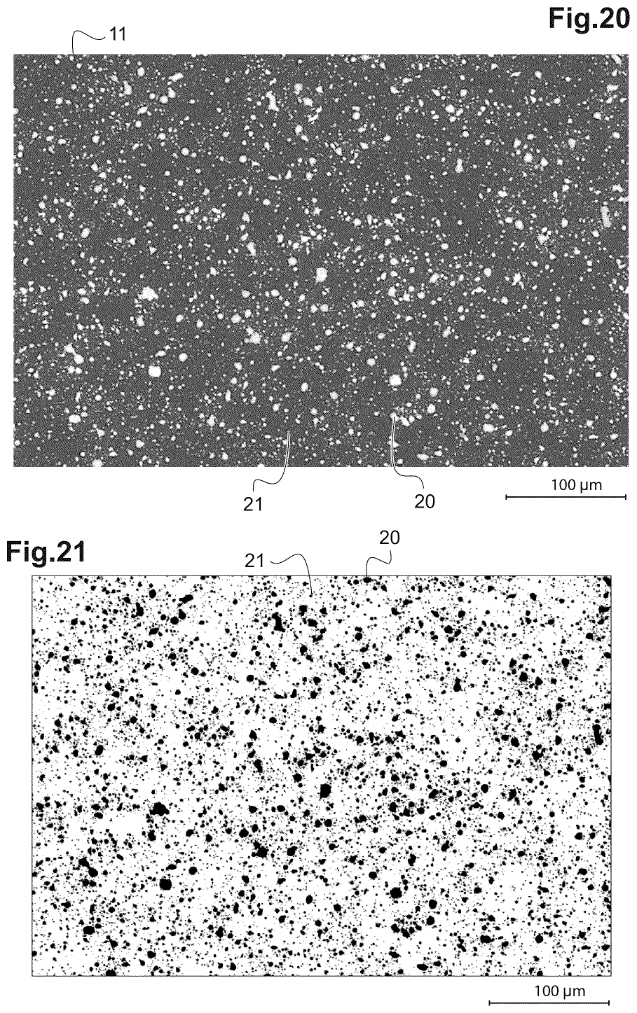

FIGS. 14, 16, 18, 20 are SEM photographs of the surface of the enameled glazed units according to the invention in examples No. 1, 2, 3 and 4.

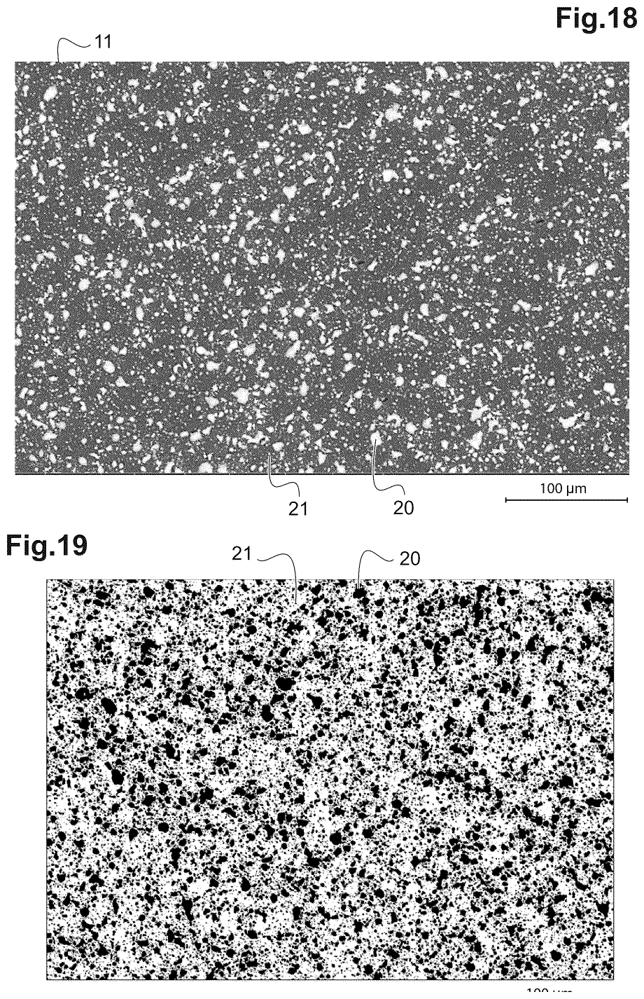

FIGS. 15, 17, 19, 21 are the preceding photographs after image processing.

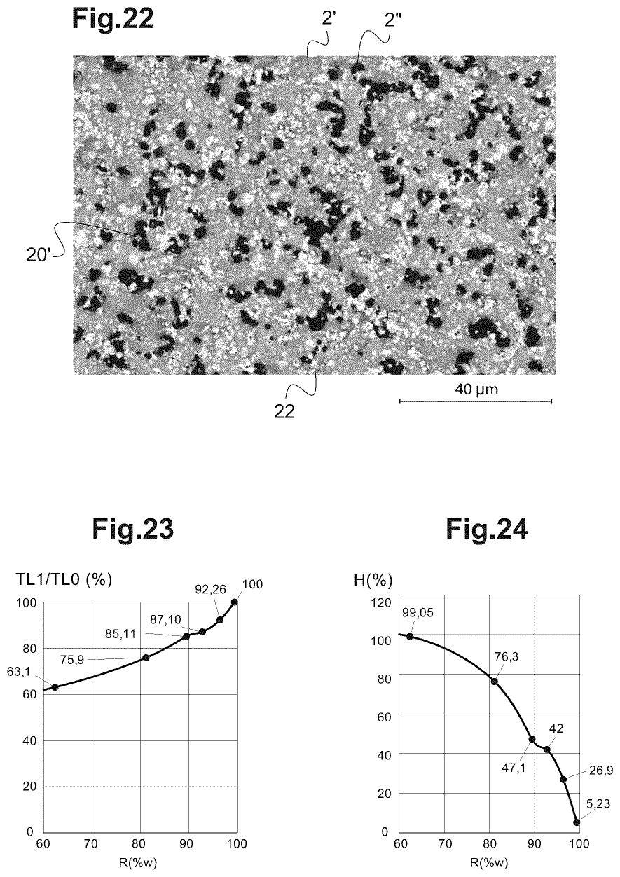

FIG. 22 is an SEM photograph of the surface of the enameled glazed unit of example No. 6.

FIG. 23 is a graph showing the ratio between the light transmission of the enameled glazed unit according to the invention (with 6 points for the aforementioned examples 1 to 6) on the light transmission of the glazed unit without enamel as a function of the R % inorganic ratio in the enamel paste.

FIG. 24 is a graph showing the (%) haze of the enameled glazed unit according to the invention (with 6 points for the aforementioned examples 1 to 6) as a function of the inorganic ratio R % in the enamel paste

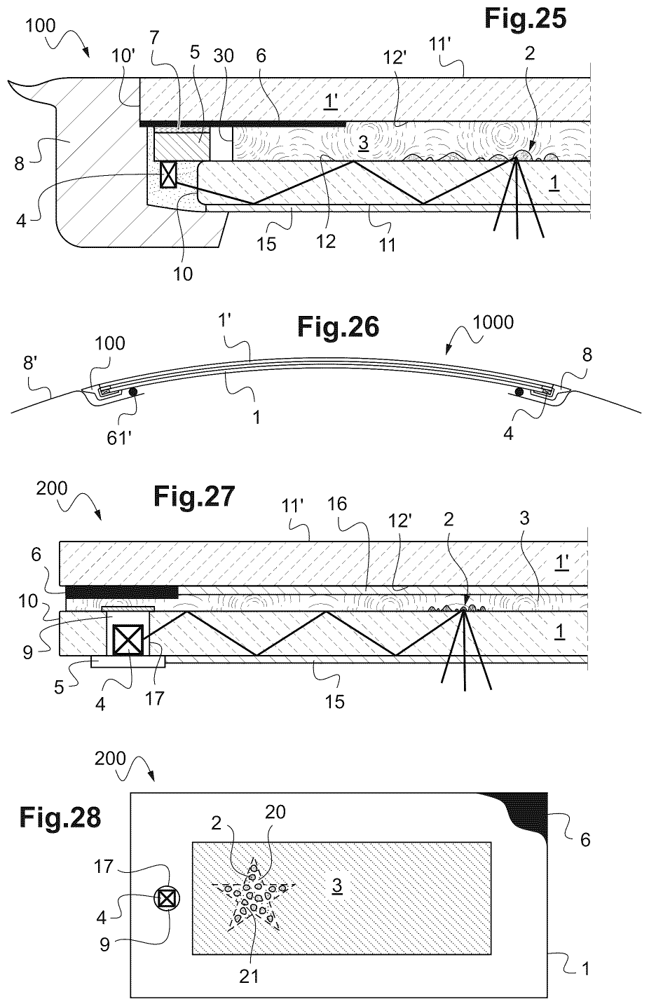

FIG. 25 shows a schematic sectional partial view of a luminous laminated glazed unit for a motor vehicle including an enameled glazed unit illuminated by the edge face in one embodiment of the invention.

FIG. 26 shows a schematic sectional view of a luminous automotive roof using a luminous enameled glazed unit according to the invention such as the one in FIG. 1.

FIG. 27 shows a schematic sectional view of a laminated luminous glazed unit (for example) including an enameled glazed unit illuminated by an internal edge face which is the wall of a closed through-hole in one embodiment of the invention.

FIG. 28 shows a schematic front view of the illuminated enameled glazed unit of FIG. 27.

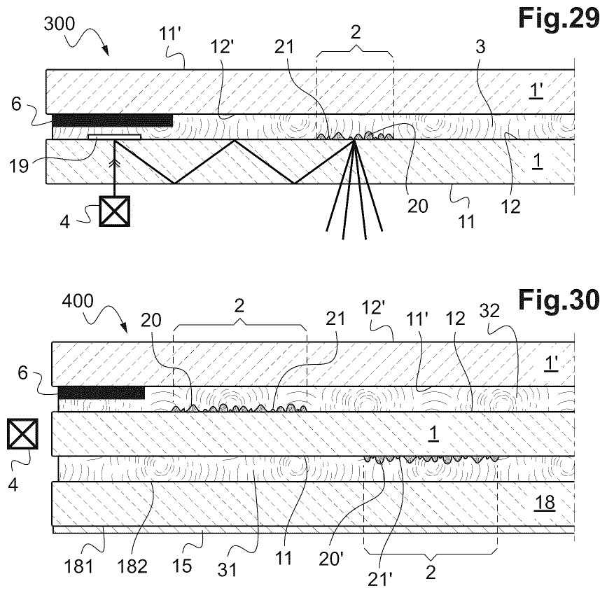

FIG. 29 shows a schematic sectional and partial view of a luminous laminated glazed unit of a motor vehicle including an enameled glazed unit illuminated via a light source in one embodiment of the invention, the light source facing Face F4 and a light-redirecting element on Face F3.

FIG. 30 shows a schematic sectional partial view of a luminous laminated glazed unit for a motor vehicle including an enameled glazed unit illuminated by the edge face in one embodiment of the invention, the enameled glazed unit being between two glass sheets.

Other details and advantageous features of the invention will become apparent upon reading the examples according to the invention shown by the following figures.

For the sake of clarity, it should be noted that the various elements of the objects that are shown are not necessarily reproduced to scale.

FIGS. 1 to 3 are schematic views of the illuminable enameled glazed unit 1 according to the invention, each including on a first main face 11 an enamel layer 2 with a plurality of transparent and translucent scattering patterns 20 allowing a view through patterns as clear, discreet and invisible as possible. The patterns are chosen as follows:

FIG. 1: set of the nine scattering rectangles (transparent and translucent) 2 with increasing variable width, for example from 2 mm to 50 mm, in particular moving away from a light injection zone, for example the edge face 10 of the glass being coupled to LEDs,

FIG. 2: set of seven scattering circles (transparent and translucent) for example centimetric

FIG. 3: two diffusing circles (for example 10 cm by 10 cm)

Each FIG. 1 to 3 has a zoomed-in view on the microscopic scale (seen by SEM) on one of the scattering features showing a set of separate enamel micropads distributed randomly with large pads 20 and smaller pads 21.

The first glass sheet is preferably made of extra-clear glass, for example OPTIWHITE of 1.95 mm. It may be curved, for example, can be used as the side of a vehicle, in particular a road vehicle, or for retail counters, etc.

The main face 11 or the opposite face may comprise a peripheral masking layer made of black enamel. The main face 11 may be covered by a functional film, for example a tinted film bonded to the first main face. To extract more light, a low index layer may be added, for example a porous silica layer on the first face under the tinted film, thus forming an optical isolator.

### I. Examples of Enameled Single Glazed Units

Six examples No. 1 to 6 are created of enameled glazed units with a discontinuous scattering layer including a first rectangular scattering pattern with a size of 3 cm by 1 cm produced by screen printing from a crystallizable enamel paste including an organic medium, a glass frit and growth seeds on a 1.95 mm Optiwhite extra-clear glass. The product DV778640 is used, including glass frit based on bismuth silicate and growth seeds (in order to grow crystals on themselves) sold by PMI with an organic medium 808018 by Ferro, based on carbohydrate/cellulose (derivative).

A 90 T screen is used.

For the various examples, the ratio R of inorganic solid is simply varied by diluting with the organic medium to a varying degree.

The enamel paste is fired beyond the glass transition temperature for 250s.

A prior step of evaporating the solvent can be carried out, for example between 100° C. and 200° C.

The enamel is glass-crystalline including a vitreous binder with microcrystals generated by firing, and growth seeds. The enamel here is translucent (semi-transparent).

In examples 1 to 5, the scattering layer forms a set of separate enamel micropads distributed randomly with large pads and smaller pads depending on the ratio R % of inorganic solid in the enamel paste.

Example 6 corresponds to a highly scattering enamel zone with holes.

Table 1 below shows for each example the ratio R0 of organic medium, the ratio R % of inorganic solid, the wet thickness (continuous film) deposited, the wet thickness E0 or E1 after firing (E1 estimated by SEM section for examples 1 to 5), the haze H, the light transmission TL, the clarity C.

TABLE 1

| | Organic | Solid | Wet E0 | E1 | | H | TL | C |
|---|---|---|---|---|---|---|---|---|
| Ex | R0 (%) | R (%) | (μm) | (μm) | | (%) | (%) | (%) |
| 1 | 81.1 | 18.9 | 14.8 | 1.8 | μm | 76.3 | 76.6 | 89.7 |
| 2 | 89.5 | 10.5 | 15.9 | 1 | μm | 47.1 | 82.5 | 95.7 |
| 3 | 92.7 | 7.3 | 16.8 | 0 7 | μm | 42 | 83.7 | 96.5 |
| 4 | 96.4 | 3.6 | 16.2 | 0 3 | μm | 26.9 | 87.1 | 98.1 |
| 5 | 99.3 | 0.7 | 14.8 | 0.1 | μm | 5.23 | 92.6 | 99.7 |
| 6 | 62.4 | 37.6 | 15.6 | 3.6 | μm | 99.05 | 69.35 | 32.5 |

Haze and clarity are preferably measured by a hazemeter (such as the BYK-Gardner Haze-Gard Plus), preferably according to standard ASTDM D1003 (without compensation). The haze of a continuous layer of this glass-crystalline enamel of thickness 15 μm is 100°.

Gloss was measured in gloss units UB with a Glossmeter, with the MICRO TRIGLOSS instrument (BYK-GARDNER) according to ISO 2813 standard (measured on the scattering layer side with an angle of 60°). The gloss ranges from 3 (example 1 or 6) to 140 (example 5). The gloss of the bare glass is 159.

Lightness was measured. The lightness ranges from 3 (example 1 or 6) to 140 (example 5). The lightness of the continuous enamel is 159.

The optical density was measured from 0.15 (example 1) to 0.05 (example 5). The optical density of the bare glass is 0.03.

This glass-crystal scattering layer is antistick. The glass sheet with the fired enamel layer can therefore be curved. The glass sheet with the enamel paste layer can be fired during curving.

FIGS. 4 to 7 are SEM photographs (magnification of 2500×) of the enameled glazed unit surface according to the invention respectively for the four examples No. 1 to 4, each showing a set of separate enamel micropads distributed randomly with large pads 20 and smaller pads 21 depending on the % of inorganic solid ratio in the enamel paste, respectively, the microcrystals 22 are seen in the large pads 20.

FIGS. 8 to 13 are photographs by SEM in cross-section of the enameled glazed units according to the invention in examples No. 1, 2 to 4, including measurements of thickness (maximum height) of the large pads 20.

FIGS. 14, 16, 18, 20 are SEM photographs (magnification of 250×) of the surface of the enameled glazed units according to the invention in examples No. 1, 2, 3 and 4.

FIGS. 15, 17, 19, 21 are preceding photographs after image processing in order to define the geometric parameters of the sets of the micropads.

The parameters Am, Bm, Tm, Cm, Pm can be determined from the processing and analysis of these four black-and-white SEM images of the surface with a scanning electron microscope at a magnification of 250×.

For the SEM images, the CBS mode is chosen to give images in chemical contrast.

For each SEM image, an image threshold is applied from 90 to 255.

For example, for image processing and analysis, the software called Image J is used. The surface area S1 is chosen for example to be 500 μm over 340 μm within the first scattering pattern.

All particle sizes are taken into account by default as well as all circularities

The number N of isolated pads is counted and the parameters Am, Bm, Tm, Pm and Cm (between 0 and 1) are measured.

The parameters are recorded in the following table 2.

TABLE 2

| Ex | N | Am (μm) | Bm (μm) | Tm (%) | Pm (μm) | Cm |
|---|---|---|---|---|---|---|
| 1 | 7466 | 2.7 | 2.0 | 26 | 6.8 | 0.89 |
| 2 | 16579 | 2.1 | 1.1 | 33 | 5.5 | 0.88 |
| 3 | 15749 | 2.0 | 1.3 | 28 | 5.1 | 0.89 |
| 4 | 11235 | 1.7 | 2.2 | 15 | 4.2 | 0.93 |

When another analysis surface area is chosen, for example 300 μm by 300 μm, similar results are found.

FIG. 22 is a SEM photograph (magnification of 1000×) of the surface of the enameled glazed unit in example No. 6.

The first scattering pattern includes a continuous enamel zone 2′ with microcrystals 22 and having separate (micrometric) openings. The openings are of irregular shape and size and are distributed irregularly. A few “particles” of enamel 20′ may be in the openings.

The previous image processing method (with the same analysis surface) is used again to determine:
the equivalent mean diameter A′m (with openings having a base reduced to a circle) of said openings which here is 3 μm
an average distance Bm between said neighboring openings which here is 4 μm
the degree of coverage T′m of said openings, which here is 15%.

FIG. 23 is a graph showing the ratio between the light transmission LT1 of the enameled glazed unit according to the invention (with 6 points for the aforementioned examples 1 to 6) on the light transmission LT0 of the glazed unit without enamel as a function of the R % inorganic ratio in the enamel paste.

This ratio naturally increases with R and ranges from about 63.1% to about 100%.

FIG. 24 is a graph showing the haze (%) of the enameled glazed unit according to the invention (with six points for the aforementioned examples 1 to 6) as a function of the inorganic ratio R % in the enamel paste.

This haze naturally decreases with R and ranges from 63.1% to about 100%.

### II. Examples of Luminous Laminated Glazed Units

FIG. 25 shows a schematic sectional partial view of a luminous laminated glazed unit for a motor vehicle including an enameled glazed unit illuminated by the edge face in one embodiment of the invention.

Here, this is a laminated glazed unit 100 which is a roof with an edge face 10 and external main faces called Face F1 and Face F4 which includes:
a first glass sheet 1, forming the internal glazing, on the passenger compartment side, for example rectangular (with dimensions of 300×300 mm for example), made of mineral glass, having a main Face 11 corresponding to the Face F3 and another main face 12 which is the Face F4, and an edge face 10, preferably rounded (in order to avoid the scales) here a longitudinal edge face (or in a variant, a lateral one), for example a sheet of soda-lime-silica glass, extra-clear, such as Diamant glass sold by the company Saint-Gobain Glass, of thickness equal for example to 2.1 mm, glass of refractive index n1 on the order of 1.51 at 550 nm or 1.95 mm Optiwhite glass, optionally with an ITO stack 15 on Face F4 (passenger compartment face)
a lamination interlayer 3, for example a clear or tinted PVB of thickness 0.76 mm, preferably of haze of at most 1.5%, with an edge face 30, here longitudinal, offset from the longitudinal edge face 10 toward the center of the glass, the lamination interlayer having a refractive index n_{f} less than n1, equal to 1.48 at 550 nm
a second glass sheet 1′, having the same dimensions as the glass 1, forming the external glazing, with a composition for a tinted solar control function (Venus VG10 or TSA 4+ glass sold by the company Saint-Gobain Glass), for example with a thickness equal for example to 2.1 mm, and/or clear glass covered with a solar control coating, or else a tinted plastic film, with a main face called internal or lamination face 12′ or F2 facing Face 12 or F3, and another main face 11′ corresponding to Face F1, and an edge face 10′, longitudinal here.

The lamination interlayer may comprise a transparent polymeric sheet for example a PET, in particular covering the surface, for example at least 90%. This sheet may be coated with a transparent electrically conductive coating, for example for the solar control and/or supply of components. For example, it involves the PVB/sheet/PVB and in particular PVB/PET/PVB assembly.

The first glass sheet 1 here includes a peripheral through-hole or recess along the longitudinal edge face 10, preferably of smaller size than the longitudinal edge face.

Light-emitting diodes 4 extend on the perimeter of the first glass sheet 1. Here these are side-emitting diodes housed in the recess. Thus, these diodes 4 are aligned on a PCB 5 substrate, for example a parallelepiped strip, preferably as opaque as possible (non-transparent) and their emitting faces are parallel to the PCB substrate and facing the edge face 10 in the recessed edge-face portion. The PCB substrate is secured for example by glue 7 (or a double-sided adhesive) on the edge of Face F2 12′, and here is engaged in a groove between Faces F2 and F3 made possible by the sufficient removal of the edge face 30 of the PVB. A peripheral masking strip 6 made of opaque enamel is added to Face F2 which can mask the PCB carrier and even the outgoing light in this zone.

The distance of the diodes and the edge face 10 is minimized, for example from 1 to 2 mm. The space between each chip and the optically coupled edge face 10 can be protected from any pollution: water, chemical, etc., both in the long term and during the manufacture of the luminous glazed unit 100.

The luminous glazed unit has a polymeric encapsulation 8, for example made of black polyurethane, in particular of PU-RIM (reaction in molding). It is two-sided at the edge of the glazed unit. This encapsulation ensures long-term sealing (water, cleaning product, etc.). The encapsulation also provides a good aesthetic finish and makes it possible to integrate other elements or functions (reinforcing inserts, etc.).

As described in document WO2011092419 or document WO2013017790, the polymeric encapsulation may have a through-recess closed by a removable cover to place or replace the diodes.

The luminous glazed unit 100 can have a plurality of light zones, with the light zone or zones preferably occupying less than 50% of the surface of at least one face, particularly with a given geometry (rectangular, square, round, etc.)

The light ray (after refraction on the edge face 10) propagates by total internal reflection (at Face F3 and on Face F4) in the first glazed unit 1 forming a light guide.

For the extraction of light, the antistick enamel scattering layer 2 according to the invention is deposited on the Face F3 12 (or F4 11 as a variant). It includes a glass-crystalline matrix 20 incorporating microcrystals and is in the form of separate pads

It is possible to provide several series of diodes (one edge, two edges, three edges, over the entire periphery, controlled independently and even of different colors. White or colored light-emitting diodes can be selected for ambient lighting, reading, etc. A red light can be selected for signaling, possibly alternating with green light.

The firing of the scattering layer 2 can be carried out before or during the bending.

The roof 100 can for example form a fixed luminous panoramic roof 1000 of a motor vehicle, such as a car, mounted externally on the body 8′ via an adhesive 61′ as shown in FIG. 26.

This laminated luminous glazed unit 100 can alternatively form a front or rear quarter-glass (optionally by eliminating the encapsulation). The scattering layer forms for example a turn signal indicator or a LOGO. If so, it is on the first clear or extra-clear glazed unit, here the outermost, on Face F1 or preferably on Face F2 on the lamination face side. Optionally, an opaque masking layer is on the inner glazed unit—tinted or not—for example, on Face F3.

This laminated luminous glazed unit can alternatively form a front or rear windshield (optionally by eliminating or adapting the encapsulation). The scattering layer forms, for example, an anti-collision signal for the driver and is on the innermost first clear or extra-clear glazed unit on Face F4 or on Face F3, in particular forming a strip along the lower longitudinal edge. For example, the light turns on (red) when a vehicle in front is too close. The second glazed unit is also a clear or extra-clear glass.

In one variant, the first glass sheet is set back from the outer glass sheet 1.

FIG. 27 shows a schematic sectional view of a laminated luminous glazed unit 200 (for example) including an enameled glazed unit illuminated by an internal edge face which is the wall of a closed through-hole in one embodiment of the invention.

As in FIG. 26, the laminated glazed unit 200a includes a first sheet 1, adhesively bonded via a lamination interlayer 3 to a second glass sheet 1′.

A through-hole 9 has been drilled through the first sheet 1, creating in the latter an inner edge 17 for housing LEDs 4 with their emitting face facing the inner edge 17 (front-emitting diodes). A solar or heating control layer 16 is on the Face F2 12′. The through-hole is blocked for example by a metal pad.

In one variant, this is a monolithic glazed unit (rear window, side window, etc.), optionally without a through-hole.

In one variant, an optical module such as a guiding element is placed between the diodes 4 and the wall 17, for example as described in patent WO2018178591.

FIG. 28 shows a schematic front view of the illuminated enameled glazed unit of FIG. 27. The scattering pattern is, for example, a star 2 formed of a set of pads 20 and small pads 21 of translucent antistick enamel.

FIG. 29 shows a schematic sectional and partial view of a luminous laminated glazed unit of a motor vehicle 300 including an enameled glazed unit illuminated via a light source 4 in one embodiment of the invention, a light source 4 facing Face F4 11 and a light-redirecting element 19 such as a prismatic film, in particular a reflective film, on Face F3 12 or prismatic film side F4 11, the hole in the sheet 1 is thus omitted. The light source 4 is still a set of LEDs. The layers 15 and/or 16 of the preceding glazed units can be retained.

FIG. 30 shows a schematic sectional and partial view of a luminous laminated glazed unit of a motor vehicle 400 including an enameled glazed unit illuminated by the edge face in one embodiment of the invention, the enameled glazed unit being between two glass sheets (the tinted exterior sheet 1 and a glass sheet 18 with main faces 182 on the interlayer side and 181 opposite) and more specifically between two lamination interlayer layers 31, 32 (PVB, EVA, etc.). The light source 4 is still a set of LEDs facing the edge face of the sheet 1. The layer 15 is kept on the innermost face 181. For example, the scattering layer is on the two faces of the sheet 1 (two offset patterns).

Of course, the laminated glazed unit of FIG. 25 or 27 or 29 or 30, in particular a road vehicle roof (motor vehicle), may comprise other elements such as:
one or more functional layers (on a PET film, etc.) within the laminate
one or more sensors
within the laminated glazed unit between the Faces F1 and F4 and even between F2 and F3, an electrically-controllable device having a variable scattering and/or tint, in particular with liquid crystals or electrochromic, or a multi-pixel screen or an additional light element, offset or facing the scattering layer
a low index optical insulator element with a refractive index less than the refractive index of the first glass sheet, between the first face and Face F2, tinted in particular between the first face and the tinted lamination interlayer, in particular a porous silica layer on the first face or a fluorinated film, in particular ETFE or FEP.

The scattering layer may be of any shape and may even comprise scattering particles as a partial or total replacement of the microcrystals, it may comprise luminescent particles and a dedicated light source, in particular UV, is coupled to the first glass sheet.

1. An enameled substrate including a first glass sheet including, on a first main face, a scattering layer made of scattering enamel, including a glassy matrix, the scattering layer including at least a first scattering pattern of at least 0.1 mm and a of given surface area S0,
wherein the glassy matrix is glass-crystalline, thus including microcrystals in a vitreous binder, the microcrystals being scattering and wherein the first scattering pattern is discontinuous,
the scattering layer includes a content by weight of coloring additives of at most 10% of the total weight of the enamel.

2. The enameled substrate according to claim 1, wherein the first glass sheet with the scattering layer has:
a light transmission factor of at least 70%,
a haze of at most 80%.

3. The enameled substrate according to claim 1, wherein the scattering layer includes a content by weight of coloring additives of at most 5% or 1% of a total weight of the enamel and even as low as 0%.

4. The enameled substrate according to claim 1, wherein the first scattering pattern including a set of separate micropads of said scattering enamel and wherein, by defining within the first scattering pattern an analysis surface S1 less than S0, S1 being at least 50 μm by 50 μm and at most 100 μm by 600 μm, and a surface area S2 which is a sum of the surfaces of the micropads in the surface S1, the first scattering pattern is defined by an equivalent mean diameter Am of the micropads of less than 10 μm and of at least 1 μm, an average distance Bm is less than 5 μm, the first scattering pattern includes a degree of coverage Tm of said micropads which is the surface S2 divided by the surface S1, Tm is less than 50%.

5. The enameled substrate according to claim 1, wherein the first scattering pattern includes an enamel zone comprising disjoint through holes, and defines, within the first scattering pattern, an analysis surface S′1 that is less than S0, S′1 being at least 50 μm by 50 μm and at most 100 μm by 600 μm, and a surface area S′2 which is a sum of the surfaces of the openings in this surface S′1, the first scattering pattern is defined by an equivalent mean diameter A′m of the openings of less than 20 μm, an average distance B′m between said neighboring openings is less than 20 μm, the first scattering pattern includes a degree of coverage T′m of said openings which is the surface area S′2 divided by the surface S′1, T′m is less than 50%.

6. The enameled substrate according to claim 1, further comprising a light source, which is optically coupled to the first glass sheet forming a light guide.

7. The enameled substrate according to claim 1, wherein the glassy matrix including a vitreous binder, the vitreous binder and/or the microcrystals of the glass-crystalline matrix is based on bismuth and/or zinc silicate or bismuth and/or zinc borosilicate.

8. A laminated glazed unit including the enameled substrate according to claim 1, comprising:
said first sheet,
a lamination interlayer, optionally tinted
and a second transparent glass or plastic sheet, optionally tinted.

9. The laminated glazed unit according to claim 8, wherein the first sheet is the internal glazing and the first main face is the internal face or the first sheet is between the second transparent sheet and a third glass sheet.

10. The laminated glazed unit according to claim 1, comprising a functional element, chosen from one or more of the following elements:
a silica layer forming an antireflective layer
a masking layer optionally adjacent to the scattering layer,
an electrically conductive layer, a layer for electrical supply of (opto)electronic components or a heating layer,
a solar control or low-emissivity layer,
within the laminated glazed unit, an electrically-controllable device having a variable scattering and/or tint, or a multi-pixel screen or an additional light element, offset or facing the scattering layer,
a low index optical insulator element with a refractive index less than the refractive index of the first glass sheet, between the first face and the second glass sheet tinted.

11. The enameled substrate or laminated glazed unit according to claim 1, wherein the enameled substrate forms a glazed unit for a land, water or aerial vehicle, or as a glazed unit for a building, and is one of:
a curved laminated roof, the first glass sheet is the internal glazing or between a second glass sheet and a transparent glass or polymer sheet,
a rear window, the scattering layer is on a passenger compartment side,
a side, laminated or monolithic, the first glass sheet is the internal or external glazing,
a curved laminated windshield, the first glass sheet is the internal or external glazing.

12. A method for manufacturing an enameled substrate which comprises formation of a scattering layer of scattering enamel on a first main face of a first glass sheet, comprising in this order:
depositing on the first glass sheet a film of a liquid vitrifiable composition forming an enamel paste, including a mixture of an organic medium and a glass frit with a glass transition temperature Tg1,
firing at a temperature Tc above the glass transition temperature Tg1 of the glass frit,
wherein the glass frit is crystallizable and the enamel paste includes growth seeds, the firing generates formation of a glass-crystalline matrix including scattering microcrystals and wherein the scattering layer is discontinuous.

13. The method for manufacturing an enameled substrate according to claim 12, wherein the firing generates a set of separate micropads of said scattering enamel, the micropads containing the microcrystals.

14. The method for manufacturing an enameled substrate according to claim 1, wherein the deposition is by screen-printing.

15. The method for manufacturing an enameled substrate according to claim 1, comprising an operation of bending the first glass sheet, said firing occurring during bending and optionally followed by tempering.

16. The enameled substrate according to claim 2, wherein the light transmission factor is of at least 70%.

17. The enameled substrate according to claim 2, wherein the haze of at most 55%.

18. The enameled substrate according to claim 3, wherein the coloring additives are black pigments.

19. The enameled substrate according to claim 4, wherein the average distance Bm is at least 1 μm.

20. The enameled substrate according to claim 6, wherein the light source includes a plurality of inorganic light-emitting diodes, and/or light is injected from the light source by an edge face of the first glass sheet or a wall of a hole of the first glass sheet or by the first main face or a second main face opposite the first main face.
